(19) United States
(12) Patent Application Publication
(10) Pub. No.: US 2009/0216663 A1
(43) Pub. Date: Aug. 27, 2009

(54) SECURE TRANSACTION MANAGEMENT SYSTEM AND METHOD

(76) Inventor: Richard J. White, Hertfordshire (GB)

Correspondence Address: FOX ROTHSCHILD LLP;Sanofi-Aventis, 2000 MARKET STREET, TENTH FLOOR, PHILADELPHIA, PA, 19103-3291, US

(21) Appl. No.: 12/090,897

(22) PCT Filed: Oct. 23, 2006
(86) PCT No.: PCT/GB2006/003933

§ 371 Date: Jan. 9, 2009

(30) Foreign Application Priority Data
Oct. 21, 2005 (GB) 0521469.7

(51) Int. Cl. G06Q 10/00; G06K 19/00; G01C 21/00; G06N 5/02; G06F 17/30; G06F 17/40

(52) U.S. Cl. 705/28; 235/487; 701/213; 706/52; 707/104.1; 707/E17.018; 707/E17.044

(57) ABSTRACT

A system (200) for managing a secure transaction comprises a secure code generator (210) for generating a first unique code and a second unique code, a database (209) for storing said first code and said second code, means for issuing (208) said first code to a first party (201) and said second code to a second party (211) and an interface (205) for inputting said first and second codes to the database (209).

The present invention generally relates to a secure transaction management system and method. More particularly, but not exclusively, the present invention relates to a secure system for managing the delivery of goods, for example the delivery and disposal of waste.

When delivering a shipping consignment, it is important that the consignment is delivered according to instructions to the correct person authorised to receive it.

Furthermore, during the shipping of goods (particularly if the goods are valuable), it is often required that, at each stage of the delivery process, the duty of care for the handling of goods passes from one person to another. For example, when managing the disposal of a waste consignment, government regulations require that the person or organisation disposing of the waste takes appropriate steps to ensure that the waste is disposed of correctly and legally. This includes ensuring that a third party they use to take the waste away is authorised to properly deal with a particular waste consignment. Every person handling the waste at each point from the place where the waste is collected to the site where the waste is disposed of is required to provide a duty of care certificate so that the regulatory bodies (for example the Environment Agency, Customs and Excise and the Inland Revenue) can obtain evidence as to how the waste was handled.

The European Waste Landfill Directive also imposes strict regulations as to where and how waste is disposed of. Fly tipping and illegal dumping of waste is currently a big problem. There are certain types of waste, for example tyres, which require special treatment before they can be disposed of properly and if illegal dumping occurs this can result in dire consequences to the environment.

Couriers and postal delivery companies currently obtain proof of delivering goods by using modern technology to track a consignment and recording a signature using, for example, using a PDA (personal digital assistant). There is often a swiped bar code strip attached to the parcel or docket. Inherent problems with this method mean that the signature obtained at the point of delivery fails to prove that the receiver was the intended recipient of the goods or authorised to sign for the goods.

The Waste Industries Operators currently do not have a reliable method of tracking the movement and disposal of waste, especially scrap tyres. The U.K. currently generates 440,000 tonnes of scrap tyres per year and France some 370,000 tonnes.

Other delivery organisations such as for example home shopping services often have to resend goods so that they reach the person who has either pre-paid or will be billed for the goods later. Causes for non delivery include theft and delivery to the wrong address or recipient. Currently there is no reliable way of securely delivering valuable items, or ensuring that a waste consignment is properly dealt with by an authorised regulated person or organisation.

There is also no way of checking that the duty of care for the goods has passed from one person to another. Although it is not normally an issue when delivering valuable goods, there is no system for validating the deliverer of goods. This is an issue if the items being delivered have a negative value in the sense that the recipient must expend time or money processing those items, e.g. waste materials. It is therefore desirable to be able to confirm both parties to a transaction. It is not possible to have a dual-sided confirmation of authenticity whereby the two parties involved in the transaction check each other. However, in many cases the value for a transaction passes in both directions and it is therefore required to have a two-way authentication of the transaction. An example of this may be the disposal of scrap tyres, where a first party wishes to dispose of the tyres and a second party disposing of the tyres is receiving money for treating and disposing of the tyres.

The present invention has been devised with the foregoing in mind.

Accordingly, one aspect of the present invention provides a method of managing a secure transaction, the method comprising generating a first code and a different second code, storing said first code and said second code in a database, issuing said first code to a first party and said second code to a second party, inputting a first input code and a second input code, comparing the first input code and the second input code input to the first code and the second code stored in the database, and outputting a transaction authentication signal if the first input code and the second input code are identical to the first code and the second code stored in the database, respectively.

Preferably the method further comprises generating a transaction key code uniquely associated with the first code and the second code and storing the key code in the database, so that at any time a party to the transaction can verify that the first and second code input to the database match that stored by the database. Only when the first and second codes are verified is the transaction authenticated.

Preferably the method further comprises issuing a receipt of the transaction upon authorisation of the transaction as proof that the transaction has taken place. A duty of care certificate can also be issued to each party at each stage in the transaction to provide proof that proper duty of care has been exercised and that responsibility for the goods involved in the transaction has been reallocated. At any time during of after the transaction has taken place, the duty of care certificates can be produced as evidence to the effect that the correct procedure has taken place and that the parties were diligent in handling the transaction.

Another aspect of the present invention provides a system for managing a secure transaction, the system comprising a secure code generator for generating a first code and a different second code, a database for storing said first code and said second code, output means for issuing said first code to a first party and said second code to a second party, an interface for receiving a first input code and a second input code, verification means for verifying that the first input code and the second input code are identical to the first code and the second code stored in the database, respectively.

The issue of the first and second codes to each party can take place remotely over a network, as can the input of the first and second input codes to the database. The system can be implemented over a network, either private or public, such as over the Internet, such that the interface and verification means are connected to the network. Each party using the system can be issued with their own unique password to access a website, where they can set up a transaction and possibly also obtain their unique code for the transaction.

Upon a transaction taking place, both parties exchange the codes they were issued with. They can then enter these into a terminal such as a particular area on the website, or into a PDA or mobile phone. If both of the codes match the codes stored in the database, then authorisation for the transaction is obtained. The transaction will only be authorised if the first code and the second code exactly match those that were issued for a particular stage in the transaction. Each party has their own unique secret code that none of the other parties to the transaction know. The two codes have a “key in lock” relationship; i.e., both of the codes input to the database must match those stored. Therefore this is a secure method of ensuring that the first and second parties are authorised to carry out the transaction.

When many separate transactions take place between two parties on a regular basis, the present invention can also provide a way of ensuring that each transaction is carried out as authorised. One transaction may involve a number of intermediate transactions or stages. In a transaction involving many different stages, the two parties involved can have a unique security code at each stage—each pair of codes will be unique and must always match the codes issued for a particular stage of the transaction.

The network can be a satellite network, mobile telephone network, fixed private or public network. The GPS or GNSS networks can also be used to locate the position of a terminal used in the transaction or associated with the courier (e.g. a GPS receiver in the delivery vehicle), and that information, as well as information about the transaction can be stored in the database.

The transaction can be the delivery of a consignment, for example a consignment of waste, valuable goods or secret documents. Preferably, information relating to the consignment is stored in the database, for example the nature of the goods, their weight and value, where and to whom they are to be delivered. This can then be verified at each stage of a transaction.

The system may also comprise a means for weighing the consignment at the points of collection and delivery, so it can be ensured that the weight of the consignment at the point of delivery is the same as the weight of the consignment when it was collected to avoid fraudulent addition to or removal of part of the consignment.

The first party can be the deliverer of the consignment and the second party can be the receiver of the consignment. However, the method and system described herein allows for many stages of delivery, from collection of the consignment at the point of collection, intermediate storage and/or treatment of the consignment, to the point of delivery of the consignment. At each stage different security codes are issued for each of the two parties. The consignment should not be allowed to change hands from the first party to the second party at each stage until each party's code is verified as matching the code that was issued. It can then be verified that the first party is authorised to deliver the consignment and that the second party is authorised to receive the consignment.

Upon successful verification of a transaction, the issuing means can also issue an invoice to the party paying for delivery of the consignment. Similarly other documents can be generated such as Duty of Care certificates, receipts for delivery etc.

Using the system and method described herein, a party delivering a consignment can specify where and when they want the consignment dealt with, and who they would like to deliver and deal with the consignment. In the case of the consignment being a waste product, there are certain organisations that are regulated and authorised by the government to deal with and dispose of waste properly. The database may contain a list of such organisations and the party wishing to dispose of the waste may choose which organisation they want to deal with and dispose of the waste and also the delivery company they wish to use to deliver the waste.

The position of the consignment may be tracked by GPS or GNSS satellite systems. A receiver in the delivery vehicle can provide information of the location of the vehicle. If the consignment does not arrive at the point of delivery at the correct time, or a courier does not arrive, the database can track the location of the vehicle and if necessary automatically deploy another party or vehicle to collect the consignment. Also, if the route taken is inappropriate or differs from an agreed route, then investigation can be undertaken to ensure that the consignment is not tampered with.

In addition to inputting two security codes to verify the transaction, the party receiving the consignment may provide their signature. However, the present system provides for greater security than current signature-based systems, in which it is difficult to verify that the person signing for delivery of the consignment is authorised to do so.

The present invention can be implemented either in hardware or on software in a general-purpose computer. Further the present invention can be implemented in a combination of hardware and software. The present invention can also be implemented by a single processing apparatus or a distributed network of processing apparatuses.

Since the present invention can be implemented by software, the present invention encompasses computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal.

Thus the present invention provides that the codes generated can be given to each party to a transaction separately. The codes are preferably unique to each party of each transaction. The codes are preferably sent electronically to each party. There are also preferably sent in a way to keep the code secret such as by encrypting them or requiring a party to enter a prearranged password or the like. This ensures that the codes are only ever passed over at the point of the transaction. This two-way exchange of unique secret codes ensures that any fraudulent transaction will be detected and avoided.

The invention is particularly effective in preventing fraud in a series of transactions where more than two parties are involved. In a series of transactions it would be difficult for a fraud to take place at one stage because the other transactions in the sequence would not correspond. For example, in a waste disposal example, the waste producer and waste disposer/processor could not falsify their papers because the haulier's unique numbers for the collection and delivery would not be known.

An example of embodiments of the invention will now be described in detail with reference to the accompanying drawings, in which:

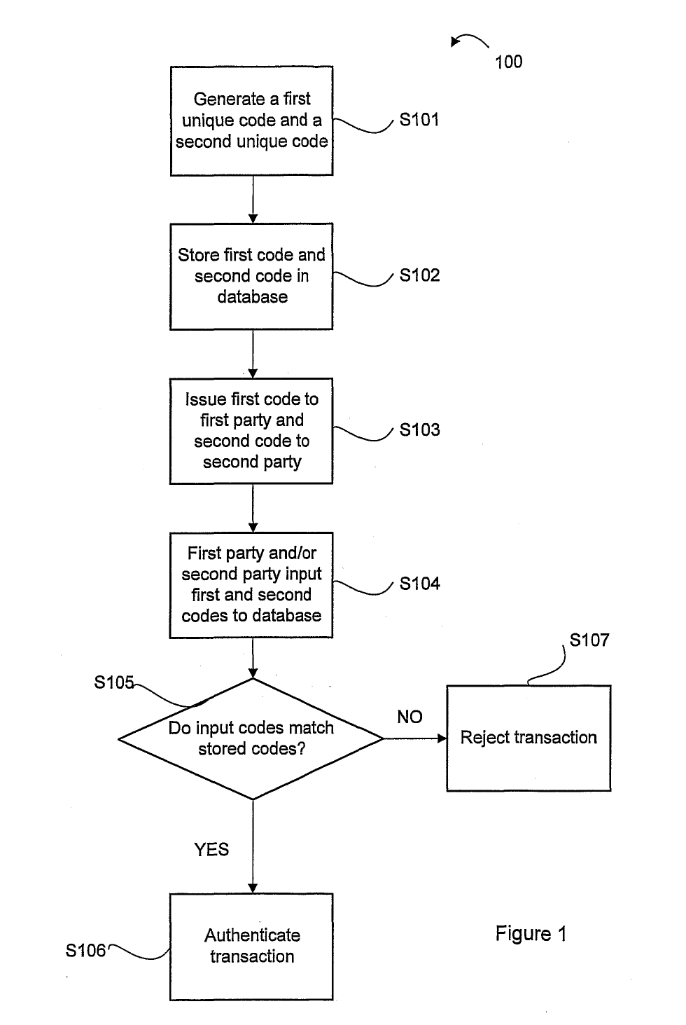

FIG. 1 is a flow diagram of a method of managing a secure transaction according to a first embodiment of the present invention;

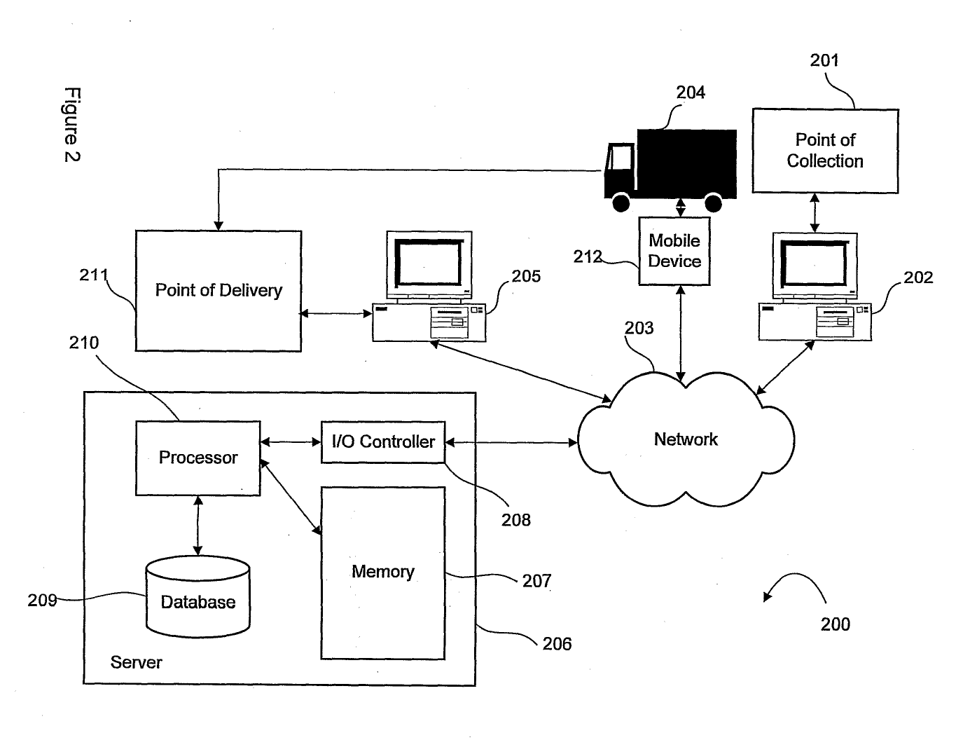

FIG. 2 is a schematic diagram of a system for managing a secure delivery of a consignment according to a second embodiment of the present invention; and

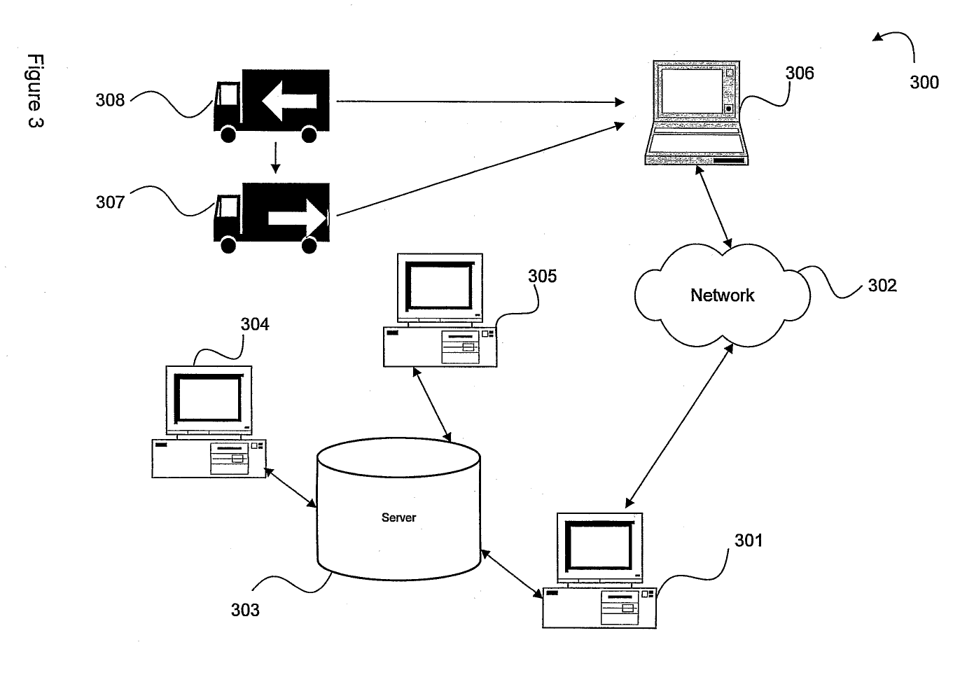

FIG. 3 is a schematic diagram of a secure waste management system according to a third embodiment of the present invention.

FIG. 1 shows a method 100 of managing a secure transaction. Parties may subscribe to a service for managing a secure transaction. A password for accessing the service is allocated to them upon subscription to the service and is unique to each party. When the parties wish to enter into a secure transaction, each party enters their unique password using an interface, such as a website for the service, displayed on a computer terminal. The party is then given access to the service for managing the transaction. Upon entering the service, for example via a web page, the party can enter details about the transaction they require, for example, the type of goods or services they would like delivered to them and where and when they would like them to be delivered. This sets up the delivery process from the point of collection of the goods to the final destination of the goods at the point of delivery.

Once a delivery has been set up by the system, every party at each stage of the transaction is issued with a unique code, which must be exchanged with and verified by the other party at that particular stage of the transaction. This maintains the level of trust throughout the process.

At step S101 a first unique security code and a second unique code are generated. Preferably the code should be a six-digit code to increase the number of possible combinations available.

The first code and the second code are then stored in a database at step S102. The first and second codes are stored in the database for the duration of the transaction and may be retained after the transaction has taken place. At step S103 the first code is issued to a first party to the transaction and the second code is issued to a second party to the transaction. In the case where the transaction is the delivery or collection of a consignment of goods, the first party will be the courier or person delivering or collecting the goods and the second party will be the provider or recipient, respectively, of the goods.

However, this process does not have to be a simple two-stage process and allows for many stages in between the collection and delivery of goods at their final destination. For example, the goods could be stored in a warehouse for a period of time between collection and final delivery. The party taking receipt of goods at the warehouse and the party delivering goods to the warehouse will also each be issued with their own unique codes different to the original codes. When the goods are collected from the warehouse, again the party supervising dispatch of the goods from the warehouse and the party collecting the goods are each issued with their own two unique codes.

At each point where responsibility for the transaction passes from the first party to the second party, the first and second parties exchange their codes with each other so that each then has both of the unique codes associated with the transaction. Either party can then input their codes at step S104. At step S105 it is determined whether the codes input at step S104 match the codes stored in the database at S102. If it is verified that the pair of codes input to the database at step S104 are identical to the pair of codes stored previously in the database at S102, then the transaction is authenticated at step S106. If however the codes input to the database do not match those already stored in the database, then the transaction is refused at step S107 and the transaction is rejected. The result of the verification is then passed to the party inputting the codes.

Since both parties each have to receive and provide their own unique codes, this ensures that no party can claim to have taken responsibility for a stage in the transaction that they are not authorised for or did not take part in. For example, this ensures that when goods are delivered to a person or organisation, the goods are actually delivered to the person who ordered them or to the person who is authorised to receive of the goods because they have the issued code. Merely signing for receipt of goods without both parties in the transaction exchanging a unique code cannot guarantee that the goods were delivered to or collected from the correct person or organisation by the correct person.

FIG. 2 shows a system 200 for managing the secure delivery of a consignment. This system implements the method described above. In this case, a party wishing to deliver or receive goods accesses the system 206. They can access the system 206 using a terminal 202, 205 or a mobile device, PDA or phone etc.

The party then enters a request to the server 206, which can include details about the consignment of goods, which organisation they would like to deliver the goods to or receive goods from and which company (for example a courier) they would like to collect the goods and deliver them to the place where they are to be delivered. Details of the delivery process are passed to the system server 206 via the network 203 (which can be, for example, the internet). The database 209 contains data including information about delivery companies and businesses that can provide or receive the goods or services that are to be delivered.

The server 206 then passes the request to the various companies taking part in the transaction.

At the point of collection of the consignment 201, there is a computer terminal 202 connected to a network 203. The consignment is delivered from the point of collection 201 to the point of delivery 211 by delivery truck 204. The delivery truck 204 contains a mobile device 212. At the point of delivery, there is a computer terminal 205 connected to the network 203.

The network 203 is connected to a server 206, which includes an input/output (I/O) controller 208, a processor 210, a memory 207 and a database 209.

A recipient at the point of delivery 211 who wishes to request delivery of a consignment 206 logs on to the server and inputs the request to the server 206 via the I/O controller 208, which processes the request in the processor 210 and stores the request in the database 209. The server then notifies the point of collection 201 via the network 203 and the computer terminal 202 that the recipient wishes to receive a consignment.

Processor 210 accesses security software from the memory 207 and generates two unique codes, one of which it passes to the computer terminal 202 and the other to the computer terminal 205 via the I/O controller 208 and the network 203. The two unique codes are also stored in the database 209. The delivery driver of the truck 204 is then given the unique code from the terminal 202 at the point of collection 201 and the recipient at the point of delivery 211 receives the other unique code from the terminal 205. Both codes are secret and secure.

When the driver of the delivery truck 204 arrives at the point of delivery with the consignment, the driver and the recipient each exchange their unique codes. These can be entered into the terminal 205 and/or the mobile device 212. Both parties can enter the codes at the same time, or they can be entered by each party at different times into different devices. The terminal 205 or device 212 then sends the two unique codes to server 206. I/O controller 208 passes the codes to the processor 210, where they are processed to check if they correspond to valid codes in the database 209. If the input codes match those already stored in the database 209, the server 206 sends a transaction authorisation message to the terminal 205 or device 212 authorising the delivery driver to hand the goods over to the recipient. The recipient also checks the delivery driver's code to make sure that the driver was authorised to deliver the goods and/or that the goods were those that the recipient ordered. If the driver's code matches that previously stored in the database 209, the recipient accepts delivery of the goods. The recipient may also have scanned their signature into the database as an extra security measure, which can be verified by the server 206 at the point of delivery 211 at the same time as the unique security codes are verified.

The computer terminals may be replaced with PDAs or mobile telephones in a wireless network and data in the network may be received and transmitted by satellite.

Furthermore, the party at the point of collection 201 may also request that a consignment of goods be collected from them and delivered to the point of delivery 211. The procedure is the same as that described above. When a party at the point of collection 201 wishes to have a consignment collected from the point of collection 201 and delivered to the point of delivery 211, they can send a request to the server 206 that they wish to have a consignment collected from them. The party can enter details about where and when they want the consignment to be collected from, which organisation they would like to deliver the consignment and who and where they would like the consignment delivered to.

As above, the processor generates a unique code for the party at the point of collection 201, a unique code for the party at the point of delivery 211 and two unique codes for the driver of the delivery truck 204, one for collection and one for delivery. When the driver of the truck 204 arrives at the point of collection 201 to collect the goods, he exchanges the first of his unique codes with the unique code belonging to the party disposing of the goods at the point of collection 201. Both of the codes are entered into the database 209 at either the terminal 202 and/or the mobile device 212. If the codes match those previously stored in the database 209, then the transaction is authenticated and authorised to proceed.

When the driver of the delivery truck 204 arrives at the point of delivery 211, he exchanges the second of his unique codes with the recipient of the goods. The second of the driver's unique codes and the recipient's unique code are both input to the database either using terminal 205 and/or the mobile device 212. If both codes match those already stored on the database then the transaction is authorised—the recipient can verify that the driver was authorised to bring the goods and the driver can verify that the recipient is authorised to receive the goods.

There may be many intermediate stages in the delivery process between the point of collection and the point of delivery. At each stage, when the consignment changes hands, each of the two parties is issued with a unique security code in the same way as described above. Ideally, the consignment should not change hands until the two codes are verified by the server as corresponding to those already stored in the database for that particular stage of the delivery. In the entire delivery process, no security code will be the same and each stage of the process has to have a unique match between security codes in order for the delivery to be authenticated to proceed beyond that point.

The server 206 may also issue Duty of Care certificates to each party in the delivery process, which provides evidence as to who was responsible for the consignment at each stage. Upon successful authentication of a consignment delivery, the server 206 can also issue an invoice to the party who took delivery of the consignment.

FIG. 3 shows a waste management system 300, which uses the system and method described above. In this case, a party wishing to dispose of waste accesses the system 300. They can access the system 300 using a terminal 301 or a mobile device, PDA or phone.

The party then enters a request to the terminal 301, which can include details about the waste consignment, which organisation they would like to dispose of the waste and which haulage company they would like to collect the waste and deliver it to the place where it is to be disposed of. Details are passed to the system server 303 via the satellite 302 (or other network, for example the internet). The server 303 contains data about waste sites and reprocessing plants suitable for and authorised to deal with each type of waste and also details of haulage contractors who are qualified to deliver waste.

The server then passes the request to the waste disposal company at terminal 304 and the haulage contractor at terminal 305. The party wishing to dispose of the waste and the waste disposal company are each issued with a unique security code and the haulage contractor is issued with two unique, different security codes, one for collection and one for delivery. When the haulage contractor arrives to collect the waste consignment, they input the first of their unique codes into terminal 301 and the party disposing of the waste also inputs their unique code into terminal 301. Alternatively the haulage contractor can carry mobile device 306 and one or both parties can enter their unique codes into the device 306—since all devices are networked to the system server 303, the codes can be entered into the server 303 by any person subscribed to the system 300 from any device. The codes are passed to the server 303, in this example, via the satellite 302 and if the codes match those issued for that particular stage in the transaction then a message is sent to terminal 301 and/or device 306 authorising the transactions. The contractor can then proceed to collect the waste. At this point, responsibility for the waste consignment passes from the party disposing of the waste to the haulage contractor. The duty of care of the waste producer is therefore completed and recorded.

When the haulage contractor arrives at the waste disposal site, they input the second of their unique secure codes at the terminal 305 and/or the mobile device 306. An authorised person at the waste disposal site also inputs their unique code into the terminal 305 and/or device 306. The codes are passed to the server 303. If the entered codes match those issued by the server 303, then an authorisation message is sent to the device 306 and the haulage contractor hands over the waste consignment to the waste disposal site. Again, the haulage contractor has exercised the required duty of care. No-one other that the party signing for the transference of ownership of the consignment knows the secure code. Thus the deliverer will have their own unique secure code for each consignment and the receiver of the consignment will also have a unique secure code known only to them and valid only for a single transaction. Equally, after exchanging codes, each party to the transaction has unique proof of the transaction that can be verified via the server at any time.

The party requesting disposal of the waste may also provide information to the server 303 of the weight of waste to be disposed. The waste is weighed by the party disposing of the waste and the weight of the waste is stored in the server 303. The delivery truck containing the waste consignment is weighed upon arrival at the waste disposal site at 308. The weight of the truck plus the waste consignment is entered into the device 306 and the weight is passed to the server 303 via the network 302 and recorded on the server 303. When the waste consignment has been unloaded at the waste disposal site, the weight of the empty truck is measured at 307 and entered into the device 306. The server 303 can then verify that the weight of waste actually disposed of at the waste disposal site was the weight of waste that the site was requested to dispose of. Instead of details about the weight of the consignment, the number of items to be disposed of can be entered into the system, for example. If the waste had to be treated before disposal, details of the treatment are also input to the system.

When required, the server 303 will issue a Duty of Care certificate to each party on request for any consignment they were involved in. The certificate indicates who had responsibility for the waste at each point in the delivery and disposal process, verifies that the receiver of the consignment has been identified as the correct person and that none of the consignment was lost or stolen or added to. The system 300 provides for automatic upload of data from the waste disposal site as each delivery vehicle leaves the site. Additional data that is stored on the server 303 includes EU waste code, which is important for the relevant regulatory bodies, and vehicle identification data. This information can also be incorporated into a Duty of Care certificate, if requested. The server 303 stores all transactions by date for every stage of every waste consignment delivery. Thus transactions may be verified as being carried out by the authorised parties at any time during or after delivery of the waste consignment has taken place.

The system 300 also provides for one delivery comprising many different waste consignments, including splitting the consignment, reprocessing original material and interim temporary storage, since each party involved with each consignment will have a unique, identifiable security code.

Furthermore, use of a GPS receiver network means that the exact location of a consignment, including the location of delivery and collection can be input to and extracted from the system.

The device 306, the delivery vehicles and/or any of the terminals 301, 304 and 305 may be enabled so as to receive GPS signals so that the location of the consignment may be tracked. In this way, the location of the waste consignment can be tracked from the point of collection to the point of disposal. This allows the system 300 to determine if the waste consignment has been lost or delayed, or if the vehicle carrying the waste consignment has made any unscheduled or unauthorised stops at locations not stored in the database 303. The GPS positioning system also allows the time at which the vehicle enters and leaves the waste disposal site to be logged.

Thus the GPS tracking helps detection of illegal waste dumping, since it can be seen whether the consignment has made any unauthorised stops to pick up additional waste or drop off some of the consignment. The positional information, along with information about the weight of the consignment and dual authorisation at each stage of the transaction determines whether the correct waste consignment has been disposed of at the correct regulated waste disposal site by an authorised person.

Although the present invention has been described hereinabove with reference to specific embodiments, the present invention is not limited to these embodiments and no doubt further alternatives will occur to the skilled person which lie within the scope of the invention as claimed.

1. A method of managing a secure transaction, the method comprising:
generating a first code and a different second code associated with a transaction;
storing said first code and said second code in a database;
issuing said first code to a first party and said second code to a second party;
inputting a first input code and a second input code;
comparing the first input code and the second input code input to the first code and the second code stored in the database; and
outputting a transaction authentication signal if the first input code and the second input code are identical to the first code and the second code stored in the database, respectively.

2. A method according to claim 1, further comprising issuing a duty of care certificate to each of said first party and said second part.

3. A method according to claim 1, wherein the step of inputting a first input code and a second input code takes place remotely over a network.

4. A method according to claim 1, wherein the step of inputting a first input code and a second input code takes place using a computer, a mobile phone or a PDA.

5. A method according to claim 3, wherein the network is a satellite network.

6. A method according to claim 1, further comprising obtaining and sending location information about the transaction.

7. A method according to claim 6, wherein the location information is obtained using a GPS or GNSS receiver.

8. A method according to claim 1, further comprising inputting and storing in said database information relating to the transaction.

9. A method according to claim 2, further comprising generating the duty of care certificate when said first input code and said second input code are identical to the first code and the second code stored by the database, respectively.

10. A method according to claim, further comprising:
inputting location information relating to the location of the transaction into the database prior to the transaction;
determining the location of the transaction; and
comparing the location information stored in the database with the determined location of the transaction, wherein
said transaction authentication signal is not output if said location information stored in the database does not correspond with the determined location of the transaction.

11. A method according to claim 1, wherein the transaction is disposal of a consignment of goods.

12. A method according to claim 11, further comprising:
storing a weight of said consignment in said database;
at the time of the transaction, measuring the weight of said consignment; and
verifying that said stored weight corresponds to the measured weight, wherein
said transaction authentication signal is not output if said stored weight does not correspond to the measured weight.

13. (canceled)

14. A system for managing a secure transaction, the system comprising:
a code generator for generating a first code and a different second code associated with a transaction;
a database for storing said first code and said second code;
output means for issuing said first code to a first party and said second code to a second party;
an interface for receiving a first input code and a second input code;
verification means for verifying that the first input code and the second input code are identical to the first code and the second code stored in the database, respectively; and
confirmation means responsive to said verification means arranged to provide a confirmation signal if the first input code and the second input code are identical to the first code and the second code stored in the database, respectively.

15. A system according to claim 14, wherein said interface is connected to a network.

16. A system according to claim 14, wherein said interface includes at least one of a computer, a PDA or mobile phone.

17. A system according to claim 14, wherein said database is adapted to also store information relating to the transaction.

18. A system according to claim 14, further comprising means for determining the position and location of the transaction.

19. A system according to claim 18, wherein the means for determining is a GPS or GNSS receiver.

20. A system according to claim 14, further comprising means for issuing a duty of care certificate if said verification means verifies that the first input code and the second input code are identical to the first code and the second code stored in the database, respectively.

21. A system according to claim 14, wherein the transaction is disposal of a consignment of waste.

22. A system according to claim 21, further comprising:
means for inputting a weight of said consignment prior to the transaction and storing said weight in said database;
means for determining a weight of said consignment at the time of the transaction, wherein
said confirmation means will not provide a confirmation signal if the determined weight does not correspond to the input weight.

23. (canceled)

24. A carrier medium carrying computer-readable code for carrying out the method of claim 1.
